(19) United States
(12) Patent Application Publication
(10) Pub. No.: US 2009/0145716 A1
(43) Pub. Date: Jun. 11, 2009

(54) DEVICE FOR DOUBLE FRICTION CONE COUPLING FOR GEARBOX

(76) Inventor: Michel Raoul, Elancourt (FR)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/088,165

(22) PCT Filed: Jul. 27, 2006
(86) PCT No.: PCT/FR2006/050757

§ 371 Date: Aug. 21, 2008

(30) Foreign Application Priority Data
Sep. 29, 2005 (FR) 0552947

(51) Int. Cl. F16D 11/04

(52) U.S. Cl. 192/53.341

(57) ABSTRACT

A device for coupling between a gearbox shaft and an idle pinion borne thereby including a hub fixed on the shaft, and a coupling mechanism equalizing by friction speeds of the shaft and the idle pinion and for transforming rotational movement received from the hub into an axial thrust on the idle pinion, so as to transmit themselves by friction the torque between the hub and the idle pinion. The coupling mechanism only includes three rings, an upper ring integral with the hub, a single intermediate ring, and a lower ring integral with the hub.

The present invention relates to synchronizers for manual or semi-automatic transmissions.

More specifically, it relates to a device for coupling a transmission shaft to an idler pinion, the latter being mounted on the shaft and comprising a hub fixed to the shaft and coupler means suitable for equalizing by friction the speed of the shaft and that of the pinion and turning the rotary movement received from the hub into axial thrust on the pinion, in such a way as to transmit the torque themselves by friction between the hub and the pinion.

Publication FR 2 821 652 discloses a special type of synchronizer using “self-assisted” friction cones, where the synchronizer sleeve does not have dog teeth, but where the coupler rings turn the rotary movement received from the hub into axial thrust against a pinion, in such a way as to transmit the driving torque themselves between the hub and the pinion by applying constant pressure to the latter.

However, the torque and dissipation capacities of that triple-cone concept are more than is required in certain applications. Also, the stacking of the cones and the fixing of the lower ring to the hub take up a large amount of space radially, which means that the input and output shafts have to be set a large distance apart.

To alleviate this problem, the coupler means according to the invention comprise only three rings, namely an upper ring attached to the hub, a single intermediate ring attached to the pinion, and a lower ring attached to the hub. The invention thus makes it possible to produce a double friction cone coupler device for a transmission.

The coupler means also comprises means for restoring the rest position comprising a spring which acts on the upper ring and pushes it back toward the hub and away from the other rings.

In another particular embodiment of the invention, the upper ring has on its inner peripheral part teeth with assistance ramps engaging with recesses with inclined sides in the hub to turn the torque of the hub into axial thrust on the other rings.

Other features and advantages of the present invention will become apparent on reading the following description of certain non-restrictive embodiments thereof, referring to the accompanying drawings in which:

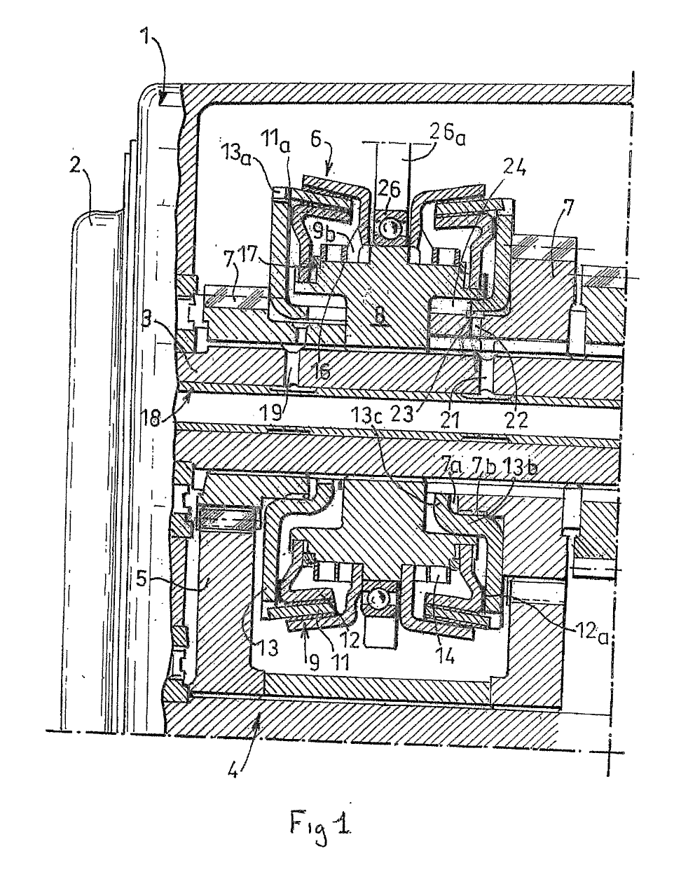

FIG. 1 is a partial view of a transmission equipped with the device of the invention in the rest position,

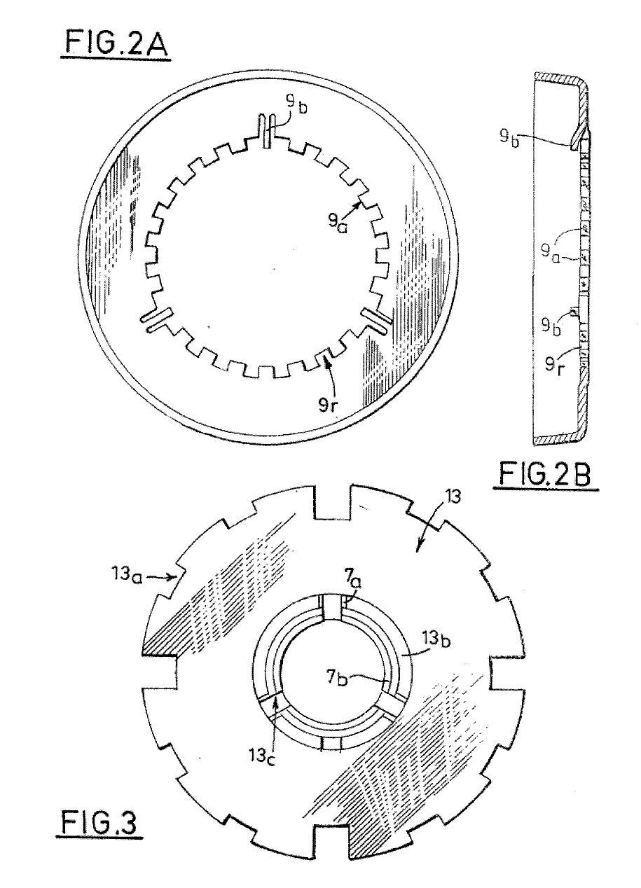

FIGS. 2A and 2B are an external view of and a cross section through the upper ring, and

FIG. 3 is a side view of an idler pinion assembled on the wheel.

FIG. 1 shows, inside a transmission casing 1 closed by a cover 2, the input shaft 3 and output shaft 4 of the transmission. On the input shaft 3 are two idler pinions 7, and on the output shaft 4 is a fixed pinion 5. A coupler device 6 between the input shaft 3 and the two idler pinions 7 is used to connect either of these pinions to their shaft. This device, which consists of two symmetrical conical couplers, is shown in the rest position. It comprises a hub 8 fixed to the shaft 3, and coupler means for coupling the hub 8 to the pinions 7. In accordance with the invention, these means only comprise an upper ring 9 attached to the hub, a single intermediate ring 11 attached to the pinion 7, and a lower ring 12 attached to the hub 8. The intermediate ring 11 is attached to a wheel 13 connected to the pinion 7.

The coupler means also comprise a spring 14 for returning them to the rest position: it may be crinkle washer arranged between two flat washers 16 retained by a circlip 17. The spring 14 acts on the upper ring 9, pushing it back toward the hub 8 away from the other rings 11 and 12.

As in publication FR 2 821 652, the coupler means are designed to equalize by friction the speeds of the shaft 3 and of a pinion 7, and to convert the rotary movement received from the hub 8 into axial thrust on a pinion 7 in such a way that they transmit the torque themselves by friction.

The upper ring 9 has teeth 9a (not visible in FIG. 1) that are provided with assistance ramps 9r which engage with recesses with inclined sides in the hub, by means of which it is able to turn the torque of the hub into axial thrust on the other rings. This ring also comprises tongues 9b visible in FIG. 1, which are bent axially away from the other teeth toward the cone, and serve as a bearing plane for the device at rest.

The diagram also shows the lubrication system of the coupler device, from the central bore of the shaft 3. The shaft 3 contains a lubricating pipe or oil distribution tube 18 pierced by feed holes 19 which coincide with the radial channels 21 passing through the shaft. The latter communicate with radial holes 22 in the pinion 7, which in turn communicate with grooves 23 cut into the material of the pinion 7 underneath the wheel 13. The grooves 23 extend partly underneath recesses 24 in the wheel 13 so that oil from the shaft 3 can completely lubricate the synchronizing rings 9, 11, 12.

The coupler device is brought into operation by the axial movement of the rings 9, 11, 12, and by the contact between the opposing conical surfaces, brought about by a ball bearing-type synchronizer sleeve 26, axial movement of which is brought about by the axial movement of a fork 26a which encircles the bearing 26.

As indicated earlier, the upper ring 9, shown in detail in FIGS. 2A and 2B, is attached to the hub 8 by teeth 9a with inclined sides 9r in the form of a dihedral. The assistance sides or ramps 9r which engage with inclined recesses in the hub to turn the torque transmitted between the hub 8 and the upper ring 9 into axial thrust on the latter. In accordance with the invention, the upper ring 9, which is preferably made from a sheet-metal blank, has a constant thickness. The teeth 9a, which are made by stamping, are distributed around the inner periphery. FIGS. 2A and 2B once again show the tongues 9b of the upper ring, which were already visible in FIG. 1. These tongues, which are also made by deformation, are at least three in number, or are grouped into three groups of tongues set out at regular angular intervals around the ring 9. The ring 9 may for example have three identical sectors of teeth 9a, and three equidistant sectors each comprising at least one tongue 9b, or a group of tongues.

The tongues 9b are bent axially away from the device relative to the plane of the ring, and bear against the spring 14 at all times. They define a bearing face which permanently receives the thrust of the spring, even when the device is in the rest position.

When the coupler device is brought into operation, the tongues 9b initially push the spring 14 out, before the ramps 9r begin to turn the torque received from the hub into axial thrust on the other rings. Because of the presence of the tongues 9b, the assistance ramps 9r do not have to push the spring 16 back themselves and can therefore be formed by simply stamping the sheet metal of the ring. Lastly, the inside conical surface of the ring 9 can be given a friction facing.

The second or intermediate ring 11 has an outer conical surface which engages with the inner conical surface of the upper ring 9, and an inner conical surface which engages with the outer conical surface of the lower ring 12. The intermediate ring 11 is attached to the supporting wheel 13 of the cone 13, by a series of lateral teeth 11a with sides parallel to its axis of symmetry, which are engaged in the recesses 13a of the wheel. The ring 11 is also preferably made from a sheet-metal blank of constant thickness and either or both of the conical surfaces can be given a friction facing.

The third or lower ring 12 is attached to the hub 8. It too can be made from a sheet-metal blank of constant thickness and its outer conical surface can also be given a friction facing. The lower ring 12 also has a surface with a friction facing 12a, preferably of the same type as that deposited on the conical surfaces, for frictional contact with the wheel 13.

The wheel 13 for connection with the pinion, illustrated in FIG. 3, consists of a flat blank perpendicular to its axis of rotation. Cut at regular intervals into its outer periphery are recesses 13a which take the lateral teeth 11a belonging to the intermediate pinion. Its cylindrical central part 13b allows assembly of the disk onto the outer part of the barrel of the pinion 7b. The connection to the pinion is provided by bent portions 13c engaging with recesses 7a cut into the barrel 7b of the pinion 7.

The connection between the wheel 13 and the pinion 7 can be by welds but this fixing method is not essential, and other types of connection between the wheel and the pinion, such as a splined connection, may be envisioned.

In conclusion, it should be stressed that the conical contacts between the various rings are independent and may be different. The contact cone angle of the upper ring and the intermediate ring is chosen to optimize the conversion of the transmitted torque into axial thrust. Lastly, the rings and the wheel may consist of cut and stamped constant-thickness sheet-metal blanks.

1-13. (canceled)

14. A device for coupling a transmission shaft to an idler pinion, the idler pinion being mounted on the shaft, the device comprising:
a hub fixed to the shaft; and
coupler means for equalizing by friction a speed of the shaft and of the pinion and turning rotary movement received from the hub into axial thrust on the pinion, so as to transmit torque themselves by friction between the hub and the pinion,
the coupler means comprising only three rings, of an upper ring attached to the hub, a single intermediate ring attached to the pinion, and a lower ring attached to the hub.

15. The coupler device as claimed in claim 14, wherein the coupler means further comprises a spring for restoring a rest position, which spring acts on the upper ring, pushing the upper ring back toward the hub away from the intermediate and lower rings.

16. The coupler device as claimed in claim 15, wherein the upper ring comprises inner peripheral part teeth with assistance ramps engaging with recesses with inclined sides in the hub to turn the torque of the hub into axial thrust on the intermediate and lower rings.

17. The coupler device as claimed in claim 16, wherein the upper ring comprises tongues bent axially out away from the teeth so as to define a position of contact between the coupler means and the hub at rest.

18. The coupler device as claimed in claim 17, wherein the upper ring comprises three identical sectors of teeth and three equidistant sectors each comprising at least one tongue.

19. The coupler device as claimed in claim 17, wherein the upper ring comprises three groups of tongues.

20. The coupler device as claimed in claim 17, wherein the tongues bear against the spring.

21. The coupler device as claimed in preceding claim 14, wherein the intermediate ring is attached to a wheel engaged in recesses in the pinion.

22. The coupler device as claimed in claim 21, wherein the wheel comprises drive tongues engaged in recesses cut into a barrel of the idler pinion.

23. The coupler device as claimed in claim 21, wherein the wheel comprises recesses that take lateral teeth belonging to the intermediate ring.

24. The coupler device as claimed in claim 14, wherein the lower ring comprises a surface with a friction facing for frictional contact with the wheel.

25. The coupler device as claimed in claim 14, wherein the rings and the wheel comprise cut and stamped constant-thickness sheet-metal blanks.

26. The coupler device as claimed in claim 14, wherein the shaft and the pinion comprise radial holes communicating with a groove cut into the material of the pinion underneath recesses in the wheel, so as to lubricate all of the synchronizer rings.
